(19) United States
(12) Patent Application Publication
(10) Pub. No.: US 2021/0016526 A1
(43) Pub. Date: Jan. 21, 2021

(54) Smart wheel system implementing a self-repairing tire apparatus

(71) Applicant: Fabio Alessio Marino, San Marcos, CA (US)

(72) Inventor: Fabio Alessio Marino, San Marcos, CA (US)

(73) Assignee: Repairing Inc., San Marcos, CA (US)

(21) Appl. No.: 16/510,999

(22) Filed: Jul. 15, 2019

(51) Int. Cl. B29C 73/02; B29C 73/16; B60B 19/06; B60C 23/04

(52) U.S. Cl. CPC B29C 73/025; B29C 73/166; B60B 2900/731; B60C 23/0498; B60B 2900/3312; B60B 19/06

(57) ABSTRACT

A new system a comprising a balanced belt that forms a ring around a wheel rim and enables smart wheel functionalities as positioning, sensing, actuation and communication hub is presented. The belt can be implemented as a removable apparatus locked around the wheel rim or as an integrate apparatus embedded in the wheel rim by a proper wheel rim manufacturing modification. The belt contains a tank filled with a sealing foam, which, in the event of a punctured tire, can be expelled out of the tank and injected into the inner part of the tire to repair the hole. With respect to the state-of-the-art systems, the proposed self-repairing tire solution, allows to avoid the cumbersome manual tire repairing operations, to save driver stress and time and to enhance car safety. Moreover, the proposed apparatus, by preserving punctured tire damaging, is very cost-effective respect to competitor solutions and contributes to carbon dioxide emission reduction. Finally, the proposed system is easy assembling, adaptable to different wheel rim sizes and reusable in case of car replacement.

### FIELD OF THE INVENTION

The present invention is in the field of smart wheel and self-repairing tires. The present invention further relates to the field of automobile related technologies. The implementation is not limited to a specific product or technology, and applies to either the invention as an individual component or an inclusion of the present invention within larger systems, which may be combined.

### BACKGROUND

Flat tires are always a nuisance. At best, they are inconvenient. At worst, they are costly and potentially dangerous. Due to the influence that tire pressure has on vehicle safety and efficiency, tire-pressure monitoring (TPM) was first adopted by the European market as an optional feature for luxury passenger vehicles in the 1980s. In the late 1990s, after more than 100 deaths from rollovers following tire tread-separation, the United States Congress legislates the TREAD Act. The Act mandated the use of a suitable TPMS (Tire Pressure Monitoring System) technology in all light motor vehicles (under 10,000 pounds), to help alert drivers of under-inflation events. This act affects all light motor vehicles sold after Sep. 1, 2007. Phase-in started in October 2005 at 20%, and reached 100% for models produced after September 2007. In the United States, as of 2008 and the European Union, as of Nov. 1, 2012, all new passenger car models (M1) released must be equipped with a TPMS. From Nov. 1, 2014, all new passenger cars sold in the European Union must be equipped with a TPMS. For N1 vehicles, TPMS are not mandatory, but if a TPMS is fitted, it must comply with the regulation. On Jul. 13, 2010, the South Korean Ministry of Land, Transport and Maritime Affairs announced a pending partial-revision to the Korea Motor Vehicle Safety Standards (KMVSS), specifying that “TPMS shall be installed to passenger vehicles and vehicles of GVW 3.5 tons or less, . . . [effective] on Jan. 1, 2013 for new models and on Jun. 30, 2014 for existing models”. Further countries to make TPMS mandatory include Russia, Indonesia, the Philippines, Israel, Malaysia and Turkey. After the TREAD Act was passed, many companies responded to the market opportunity by releasing TPMS products using battery-powered radio transmitter wheel modules [1]. An internal OEM TPMS sensor (1) is shown in FIG. 1, while an external set of aftermarket TPMS sensors (2) and the corresponding monitor (3) are depicted in FIG. 2.

The introduction of run-flat tires further improved safety, but this technology is quite expensive. A run-flat tire is a pneumatic vehicle tire that is designed to resist the effects of deflation when punctured, enabling the vehicle to continue to be driven at reduced speeds—under 56 mph (90 km/h) for limited distances, generally between 10 mi (16 km) to 50 mi (80 km), depending on the type of tire.

Nowadays, more and more cars adopt OE (Original Equipped) emergency flat tire repair products that promise of getting you back on the road quickly, without having to mount a spare tire or call a tow truck. Aftermarket tire repairing kit are also available.

These type of products have been around for years. They work by pumping a sealant containing small rubber particles into a flat tire, plugging small punctures from the inside. Sealant kit popularity has been accelerating as they become common-place on new cars, where they are replacing the traditional spare tire for sake of weight and fuel consumption savings. Pressurized-can sealers, such as the ubiquitous Fix-A-Flat, are one-time-use products that have a dispensing tube that connect to tire's air-inflation valve. These sealers can both patch a hole and inflate the tire. More expensive tire-sealant kits combine a portable 12-volt air compressor and a replaceable container of sealant.

Despite their roles, these products are not spare tires in a can. They should only be used for tires that are technically repairable, by sealing a small hole only in the tread, and with the understanding that the fix is strictly temporary. No attempt should be made to repair a hole larger than 6 mm in diameter or a cut or hole in a sidewall. With that kind of damage, the only option is replacing the tire. If a tire sealant is used, the tire should be repaired or replaced professionally as quickly as possible (typically within 100 miles or as directed by the product). However, when a tire is punctured, all flat tire-repairing kits force the driver to get off the car, with great stress and waste of time. Whereas, even if run-flat technology avoids the driver from getting out of the car, it does not prevent tire damaging and, consequently, the expensive tire replacement.

In the recent years, several companies have introduced a new kind of tire embedding electronic components so as to enable exchange of information toward a central system. These new kind of tires, usually referred to as smart tires, aim to embed different functions, such as the ability to monitor pressure, temperature or other local parameters and transmit the collected data to a central unit. The present invention describes a new solution to implement smart wheels including and not limited to a tire self-repairing system aimed to overcome the above described limitations of conventional tire repair kits.

### BRIEF SUMMARY OF THE INVENTION

The disclosed system comprises a sensor/actuation/communication hub between the wheel and a central unit, and it incorporates a integrated or removable tank containing a sealing foam and/or air, electronics, actuators and/or sensors, and one or more energy sources. In one of its embodiments, the disclosed system comprises a balanced belt/ring shaped tank hooked around the wheel rim (in the removable system version), or integrated in the wheel rim itself (in the integrated solution). With respect to state-of-the-art products, the proposed low-cost approach provides a modular solution to preserve tire conditions in case of tire puncturing and avoid cumbersome manual tire repairing operations, saving stress and time to the driver. Moreover, the proposed system, by preventing punctured tire from further damaging, becomes very cost-effective with respect to run-flat solutions. With respect to self-repairing tire solutions, where one or more layers of sealant are integrated in the tire itself, the proposed solution allows to detect puncturing events and to warn the driver about tire problems greatly enhancing car safety. Moreover, since statistically cars undergo to one tire repair every 47,000 mi (75,000 km) and full tires replacement every 15,700 mi (25,000 km), one tire repair will happen on average only once every 3 full replacements, i.e., once every 12 tires changes, which makes the self-repairing tire solution not very cost effective. The proposed system is instead reusable in case of tire replacement or, depending from the implementation, even car replacement. Finally, the proposed system is easy to assemble and adaptable to different rim sizes and contributes to carbon dioxide emission reduction.

### BRIEF DESCRIPTIONS OF THE DRAWINGS

The features, objects, and advantages of the present invention will become apparent upon consideration of the following detailed description of the invention when read in conjunction with the drawings in which:

FIG. 1 depicts a typical internal OEM TPMS sensor.

FIG. 2 illustrates a typical set of external aftermarkets TPMS sensors.

FIG. 3 shows an example of implementation of the proposed invention.

FIG. 4 shows a scheme of the proposed system based on an integrated tank containing a liquid sealing foam integrated into wheel rim.

FIG. 5 shows a scheme of the proposed system based on a tank containing a liquid sealing foam hooked around the wheel rim.

FIG. 6 depicts a removable embodiment of the present invention where the system installation has been implemented by using two semi-circular parts connected through a hinge.

FIG. 7. depicts a removable embodiment of the present invention where the system has been placed externally to the tire using a disk shaped implementation.

FIG. 8 shows an alternative embodiment of the present invention using a micro motor, an actuated piston and a termination piston.

FIG. 9 shows possible implementations of the connection between the micro motor and the actuated piston: two rigid (a) and (b), a semi-rigid (c) and a wire-bonded (d).

FIG. 10 shows a further embodiment of the present invention implemented with a Loop Tank and 2-WAY Open/Open-Closed/Closed Electro Valve (OO-CC EV).

FIG. 11. shows an alternative implementation of the 2-WAY OO-CC valve system for the embodiment of FIG. 10.

FIG. 12 shows a synchronous multi-WAY OO-CC Latched Electro Mechanical Actuator according to a further embodiment of the present invention.

FIG. 13 shows an alternative embodiment of the present invention using a micro motor and two actuated pistons.

FIG. 14 shows the possible connection implementation between (a) one micro motor and the two actuated pistons and (b) two micro motors and the two actuated pistons.

FIG. 15 shows an alternative embodiment of the present invention using (a) a micro pump and a termination piston and (b) a micro pump and a plug.

FIG. 16 shows an alternative embodiment of the present invention using a hyperbaric chamber, a normally closed electro valve and a plug.

FIG. 17 shows two alternative embodiments of the present invention using an air-chamber tank with (a) a pneumatic valve and a sealant valve and (b) a proper two-way valve.

FIG. 18 shows the details of the preferred embodiment of the present invention using an air-chamber tank with a pneumatic valve and a sealant valve.

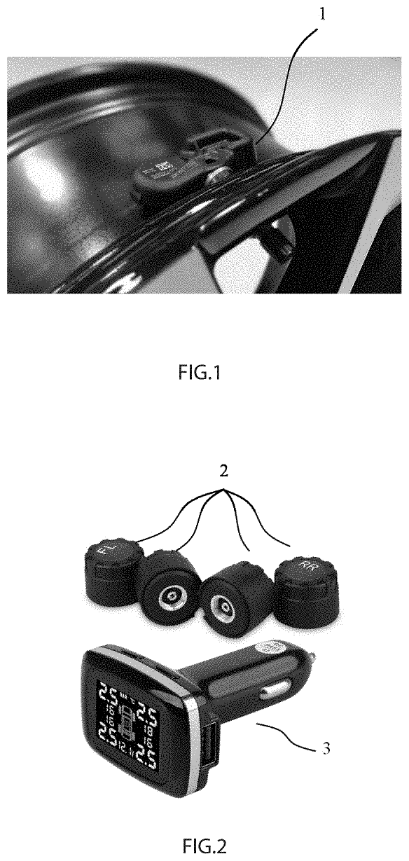

### DETAILED DESCRIPTION OF THE INVENTION

The present invention will now be described in detail with reference to certain embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known details have not been described in detail in order not to unnecessarily obscure the present invention.

The disclosed tire repairing system according to the present invention comprises one or more of the following elements: a communication module to enable information exchange between the wheel and a central or mobile unit, an integrated or removable tank containing a sealing foam and/or air, electronics, actuators and/or sensors, and one or more energy sources. A balanced belt that forms a ring around a rim, or a disk attached to the external part of the rim, are used in the removable version to enable the smart wheel functionalities by implementing a positioning, sensing, actuation and communication hub; in the “integrated” version of the system the tank and the electronics are directly integrated inside the wheel rim.

When TPMS reveals that a tire is punctured, the driver, by a command, forces the liquid sealant foam to flow out of the tank in order to repair the tire. If desired, the system can be also completely automatic by setting a threshold on the deflating speed and/or level, so that the liquid sealant foam is automatically forced to exit the tank in order to repair the tire if the tire deflates too fast and/or under an unsafe level.

With respect to the state-of-the-art products, the proposed low-cost solution, by a simple command or automatically, allows to avoid to the driver tedious and stressing manual tire repairing operations (typical of flat-tire repairing kits) while enhancing car safety. Indeed, the prompt intervention of the proposed system preserves the damaging of the punctured tire, thus being very cost-effective with respect to the run-flat solution. The advantages of the proposed solution, with respect to TPMS and run-flat solutions, are schematically depicted in the following table.

| | | | | TPMS + |
|---|---|---|---|---|
| | | | TPMS + | run-flat + |
| | Only | TPMS + | proposed | proposed |
| | TPMS | run-flat | solution | solution |
| Signaling Pressure | good | good | good | good |
| Reduction | | | | |
| Driving <80 km/h | bad | good | good | very good |
| after Pₗₒₛₜ | | | | |
| Tire conditioning | bad | fair/bad | good | good |
| after 80 km & Pₗₒₛₜ | | | | |
| Long-term cost | fair/bad | bad | good | fair/good |
| solution | | | | |

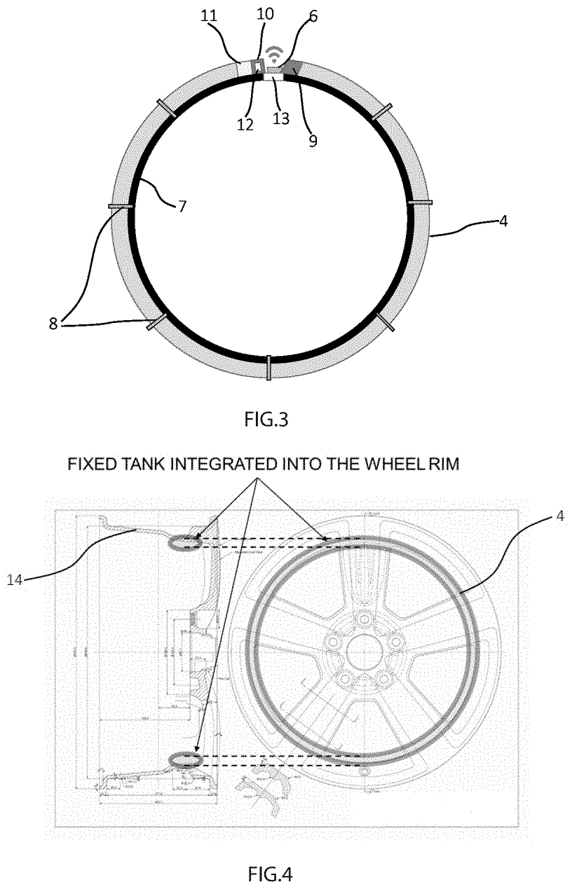

In its general implementation, the present invention comprises a controlled or self-actuating tire repairing system based on an integrated or removable tank containing a sealing liquid foam. A first embodiment of the present invention, depicted in FIG. 3, comprises one or more of the following elements:
a tank (4) containing the sealant liquid foam, which can be integrated in the wheel rim structure (in the integrated solution); or removable and hooked around the wheel rim (in the removable solution); it can be implemented with multi-layer of any combination of plastics, fibers, metals including metal net;
a communication module (6) used to control the actuation mechanism and/or to warn the driver that the actuation mechanism has been enabled. Furthermore, the communication module can be used to exchange data from/to one or more tires and a central communication system.
an actuation mechanism (9) to release the sealant liquid foam inside the tank when a control signal is received, such as a 2-way normally closed solenoid valve which permits the sealant liquid foam to exit the tank when required;
a sensing module (10) to monitor a set of environmental parameters inside the wheel such us pressure, temperature, acceleration, (e.g. TPMS); the sensing module could provide the data to the communication module (6) or it can directly drive the actuation mechanism (9) to open the tank (4), when for example a critical pressure variation inside the tire is sensed.
a pressure balancing mechanism (11) to maintain the isostatic balance between pressurized air inside the tire and the sealant liquid foam inside the tank (4), such as a non-return valve;
a sealant liquid foam recharging system to recharge the sealant liquid foam into the tank (4), which can be implemented, for example, by exploiting the non-return valve of the pressure balancing mechanism (11) or the 2-way normally closed solenoid valve of the actuation mechanism (9);
an energy source (12) and supply connections to supply energy to one or more functional blocks of the proposed system, such as the communication module (6), the sensing module (10) or the actuation mechanism (9). The energy source (12) supplies energy to electronics of the actuation mechanism (9) and electronics of modules (6) and (10) to permit the remote control of the system by the user or by the car computer (for example, by means of Bluetooth, low energy Bluetooth, or Zigbee technology). The energy source (12) can be a battery, which may or may not be accessible to be changed.
   The removable implementation further comprises elements to allow the mounting of the system on the wheel rim, such as:
a fastening mechanism (7) which allows the system to be fasten around the wheel rim (e.g. by several fastening clips (8)); based on the locking mechanism implementation, it could be not needed; in general the ring or belt could comprise side flaps to increase the contact surface with the rim for a better adhesion; the belt and or the fastening mechanism can be implemented with multi-layer of any combination of plastics, fibers, metals including metal net;
a locking mechanism to secure the fastening mechanism around the rim (13).

### The Tank

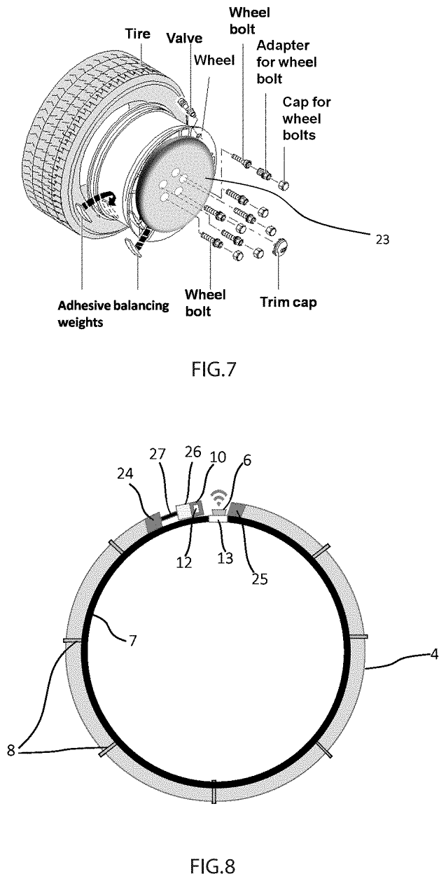

In the integrated implementation of the present invention depicted in FIG. 4, the tank (4) is integrated into the wheel rim itself (14) (e.g. in the center of the rim or in the side-walls). In the removable implementation of the present invention sketched in FIG. 5, the removable tank (4) is instead hooked around the wheel rim (14) (typically on the side-walls) or, as shown in FIG. 7, the removable tank is inside the block (23), which is placed externally to the tire.

In the illustrated embodiments of FIG. 3-5, the tank container runs around the wheel rim for one turn. However, the system can be altered so that the tank length is not limited to a single turn of the rim (e.g. by using balancing weights to counter act the system weight). Other solutions envision a tank length less than one complete turn around the wheel rim or more than one turn. In general, the proposed system can be integrated in any portion of the rim (or tire), e.g. the tank can be also integrated in the center of the wheel rim under the center cap bore and/or in the center disc and/or in the center bore and/or along one or more of the wheel spokes.

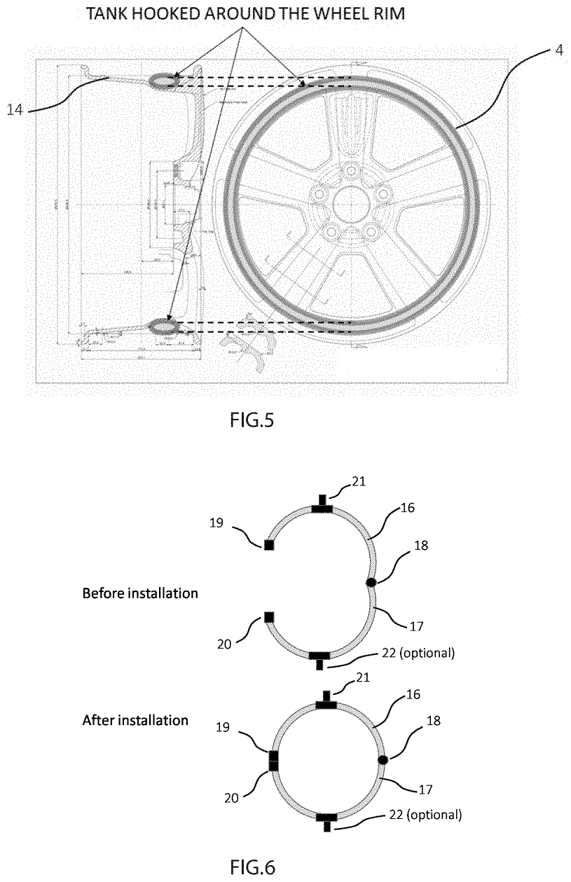

The tank system can be completely flexible or completely rigid, or it can comprise flexible, and/or rigid, and/or semi-rigid portions; tank cavity has a shape belonging to the group comprising circular, elliptic, square, rectangular, polygonal, and shapes comprising flat and curved sides. In the removable embodiment shown in FIG. 6 (a) and (b) before and after installation, respectively, the tank is composed by two rigid (or semi-rigid) semi-circular half-tanks (16) and (17) connected by a hinge (18). By fasting the belt through the locking mechanisms, (19) and (20) as shown in FIG. 6 (b), the system can be therefore installed very quickly on the wheel and, vice versa, instantly removed. The two half-tanks can be independent one from the other or they can be connected through a flexible junction (placed across or along or overlapped to the hinge) to allow for the sealant liquid foam to flow from one side of the tank to the other one (alternatively, only one of the two semi-circle can comprise a tank, while the other is used only as fastening belt or to embed energy source/communication system/sensors).

In further embodiment of the present invention, the tank is formed with a flexible inflating air-chamber, discussed in more details in [0042] (similar to the inner tube used in a bicycle tire) placed around the internal rim. This particular type of tank allows the system to be easily assembled around the wheel rim before mounting the tire.

In a further embodiment of the present invention, the smart wheel system is implemented in an external add-on structure, e.g. an external disk (23) as shown in FIG. 7, which is then attached (externally to the tire, e.g. laterally) to a wheel and connected to the tire through the conventional tire valve (or valve opening by usage of custom valve) to allow for the sealant liquid foam and/or (compressed or not) air to flow inside (and/or) outside the tire when desired. An external valve can be added to the structure to allow for the by-pass of the add-on structure and/or for recharging the add-on structure fluids (and/or air tank). The internal part of the add-on structure (23) can be composed of an extensible tube, which exerts a pressure on the internal sealant liquid able to push out the sealant liquid and to win the internal pressure of the air in the tire when the conventional valve is open. Alternatively, the conventional valve, or another valve, may be a remotely controlled electro valve (preferably latched-type) or a manually operating valve.

### The Comunication Module

In one embodiment of the present invention, a communication module is used to control the actuation mechanism or to warn the driver that the actuation mechanism has been enabled. The communication link can be established with a central unit in the car or by means of a phone paired with the system with dedicated app allowing the system control from the phone itself. In general, however, a smart wheel according to the present invention can be efficiently equipped with different types of communication modules. Furthermore, different smart wheels of a vehicle can implement and/or have different functions. For example, all four (or more in case of a truck) smart wheels of a vehicle could comprise RF modules such as but not limited to Sub-GHz, Bluetooth Low Energy or Zigbee RF modules to exchange data with the computer of the car, and only one smart wheel, named “master smart wheel”, could further implement any combination of Wi-Fi, GSM, LTE or 5G RF modules to enable connection with communication networks external to the car. A global navigation satellite system module (e.g., GPS, GLONASS, Compass, Galileo, DORIS, IRNSS, QZSS, etc . . . ) could be mounted only in one smart wheel of the car (typically the master) to determine the wheel/car positioning. Other sensors able to analyze the air quality and the combustion fumes, or accelerometers, IR sensors and video cameras able to analyze the road surface conditions, corrosion, etc . . . , could be mounted on a part of the bodywork of the car and exchange data with the computer car through at least one smart wheel.

The set of smart wheels of all cars equipped with the proposed system, which mutually exchange data between each other using car-to-car communication networks and protocols or exploiting any internet access point infrastructure in the vicinity of the road, create the INTERNET-OF-WHEELS concept. This telecommunication system between smart wheels of different cars, by means of proper algorithms, could monitor and share information on the reliability of the road surface and on the quality of the surrounding air and/or provide real time traffic information. For example, the INTERNET-OF-WHEELS could be exploited to send alarm signals immediately after an accident and to give detailed information in the event of a fire following an accident, or to report the presence of road potholes to the competent authorities, or to warn other cars of a slippery road surface due to the presence of oils, water, debris or sand. Moreover, the INTERNET-OF-WHEELS concept could be exploited to automatically signal the presence of forest fires, landslides, sightings of animals on the street or the presence of cars in need of help on the road.

### The Actuation Mechanism

In the illustrated embodiment of FIG. 3, the actuation mechanism (9) used to control the flux of sealant liquid foam from the tank (4) into the tire, can be implemented by a 2-way normally closed solenoid valve which permits the sealant foam to exit the tank when required. Alternatively, the actuation mechanism (9) can be implemented by one or more hydraulic micro pumps.

In the embodiment of FIG. 6, a 3-way valve (21) is used to release the foam when required. The same valve or another 3-way (or different) valve (22) can be used to recharge the foam in the unit. Other variants include the placement of one or more valves directly in (or overlapped to) the locking mechanism (19) and/or (20). The openings of one or both valves (21) and/or (22) can be directly accessible from outside the rim (as the tire pressure valves of today's tires) or only when the tire is removed. Furthermore, the opening of the valves can point outside the ring as depicted in figure or it can be placed in any other direction.

Instead of using an electro-valve as actuation mechanism, a motorized actuator, said micro motor, can be used. Moreover, instead of using a non-return valve as tank pressure balancing mechanism, a termination piston can be used. An example of such implementation is shown in FIG. 8, where the tank (4) is equipped with an actuated piston (24) and the termination piston (25). The micro motor (26) is able to exercise, by a connection (27), the needed force to push or pull the actuated piston (24) from the tank (4) and allowing the internal sealant liquid foam to get inside the tire when needed;

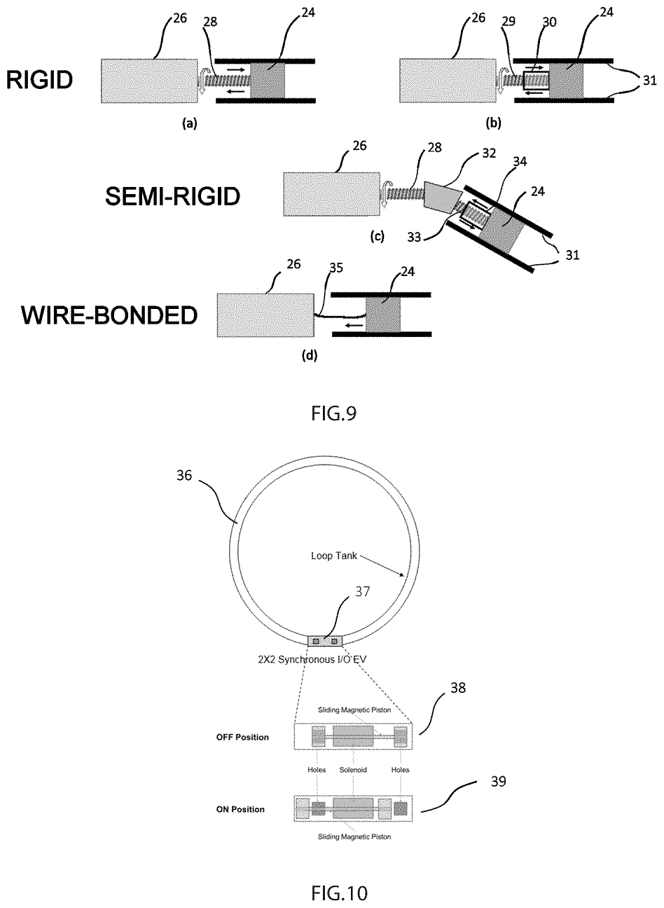

Micro motor to actuated piston connection (27) can be rigid, semi-rigid or wire-bonded, as depicted in FIGS. 9 (a)-(d):
In rigid connection between micro motor (26) and actuated piston (24) of FIG. 9 (a), the gear motor (26) impresses a rotation to a screw (28) anchored to the actuated piston (24) thus allowing the axial movement of the actuated piston when the screw (28) goes inside/outside the micro motor (26).
In rigid connection between micro motor (26) and actuated piston (24) of FIG. 9 (b), the gear motor (26) impresses a rotation to an endless screw (29) which impresses an axial movement to a solid cylinder (30) anchored to the actuated piston (24) thanks to the friction between the actuated piston (24) and the internal surface of the tank (31).
In semi rigid connection between micro motor (26) and actuated piston (24) of FIG. 9 (c), the gear motor (26) impresses a rotation to a first screw (28) which is linked to an articulated joint (32) to transmit a rotation to a second endless screw (33) which impresses an axial movement to a solid cylinder (34) anchored to the actuated piston (24) thanks to the friction between the actuated piston (24) and the internal surface of the tank (31). In wire-bonded connection between micro motor (26) and actuated piston (24) of FIG. 9 (d), the gear motor (26) pulls a string (35) which is bonded to the actuated piston (24) thus forcing it to do an axial movement.

Another implementation of the actuation mechanism, is based on a 2-way Open/Open-Closed/Closed (OO-C) Electro Valve (37), as schematically depicted in FIG. 10. Details of the 2-way OO-C Latched EV in OFF (38) and ON (39) positions are also shown in the bottom part of FIG. 10. Another possible embodiment for the 2-way OO-C Latched EV in OFF (40) and ON (41) positions is shown in FIG. 11.

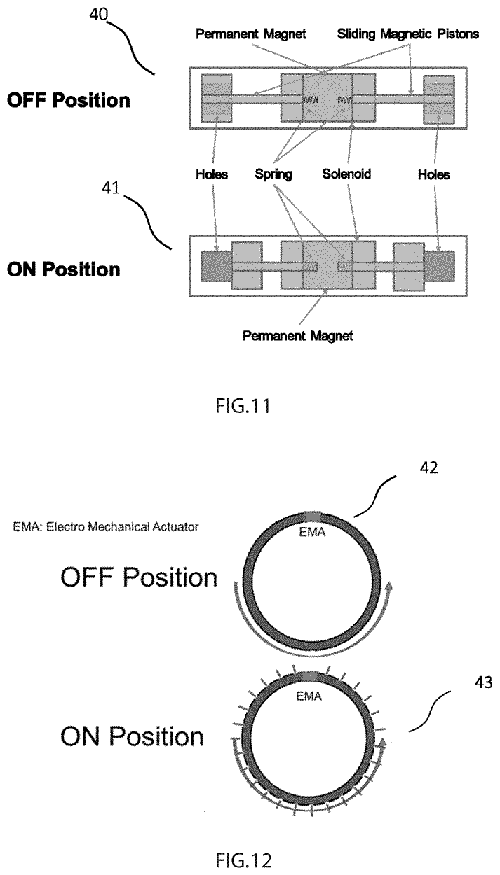

In the alternative embodiment of FIG. 12, the 2-way OO-C Latched EV can be substituted with an Electro Mechanical Actuator (EMA) able to OPEN or to CLOSE simultaneously many holes at the external part of a loop tank, as depicted in the Figure, during ON (42) and OFF (43) operations.

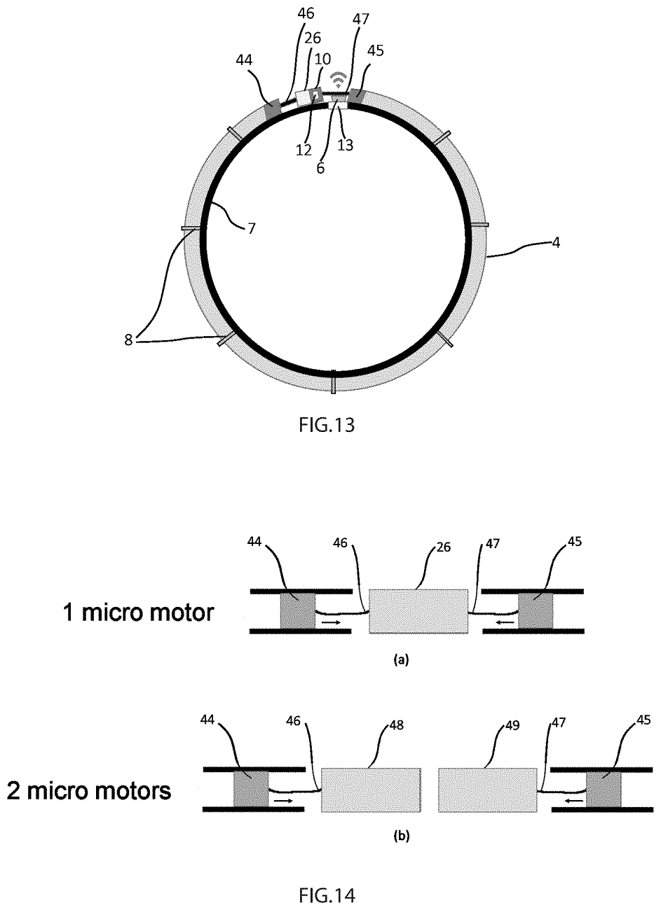

FIG. 13 shows the key components of an alternative implementation, which is a possible variant or the previous implementation of FIG. 8. In this case, the two pistons (44) and (45) are actuated by one micro motor (26) by means of two wire-bonded connections (46) and (47), as shown with more details in FIGS. 14 (a). Alternatively, as shown in FIG. 14 (b), the two pistons (44) and (45) can be actuated by two micro motors (48) and (49), by means of two wire-bonded connections (46) and (47). Many other variations are possible, as previously discussed for the single opening actuation mechanism.

### Sensing Module

Optionally, the system could have autonomous sensors (such as, accelerometers, vibration sensors, temperature sensors, etc . . . ) in the electronic circuit implementing the sensing module (10), for example, to automatically activate the actuated piston (24) thus opening the tank (4) when a significant pressure variation inside the tire is sensed (Local TPMS or an in-wheel one could be exploited to collect info).

### The Pressure Balancing Mechanism

The second extreme of the tank, the one not comprising the actuation mechanism, can be simply closed in a permanent or semi-permanent way (e.g. by means of a plug) or it can be used to help to control the pressure inside the tank. This can be done, for example and not limited, by using a non-return valve (such as element (11) in FIG. 3) or a termination piston (such as the element (25) in FIG. 8), where the piston is free to move back and forth so as to maintain an isostatic pressure between the tire chamber and the tank. The termination piston (25) in FIG. 8 is set to be able to only move in the tank with enough movement space to assure the control of pressure in entire range the tank can suffer variation within the normal wheel operation (typically, 0-3 BAR);

In the case where a wire-bonded connection (35) is used between the micro motor (26) and the actuated piston (24), such as in FIG. 9 (d), the actuated piston (24) is able to move to keep the internal tank pressure equal to the tire pressure while keeping the sealant fluid foam inside the tank (4), thus intrinsically implementing the tank pressure balancing mechanism.

In other embodiments of the present invention where the pressure balancing mechanism is not implemented, the non-return valve (11) of FIG. 3 can be replaced by a 2-way normally closed solenoid valve to control the flux of the sealant liquid foam into the tire. In this case, the two 2-way normally closed solenoid valves are simultaneously opened to allow the sealant liquid foam to get inside the tire or closed to maintain the sealant liquid foam inside the tank (4).

### Further Actuation Mechanisms

In FIG. 15 (a), the key components of an alternative implementation of the proposed system are displayed. In this embodiment, the actuation mechanism is obtained by means of a micro pump (50) able to exercise the needed pressure to push the termination piston (51) out of the tank (4) in order to allow the internal sealant fluid foam to get inside the tire when needed.

In the embodiment of FIG. 15 (b), the termination piston (51) of the FIG. 15 (a) is replaced with a plug (52) which is pushed out of the tank (4) to allow the internal sealant fluid foam to get inside the tire when the micro pump (50) exercises the proper pressure on the internal liquid, when needed.

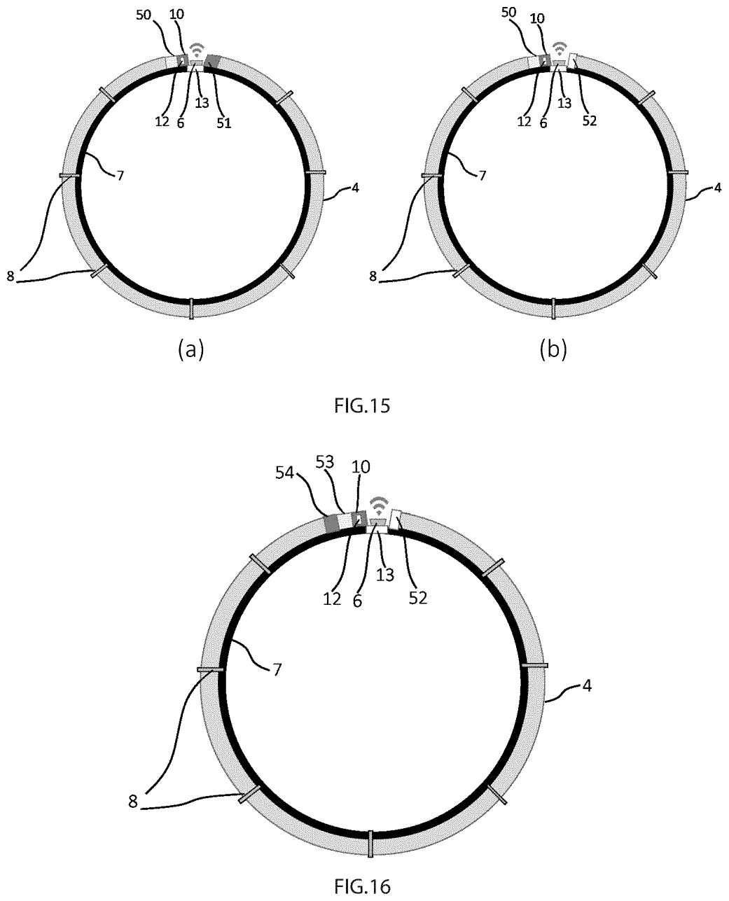

In FIG. 16, the key components of an alternative implementation, of the proposed system, are displayed. With respect to the implementation of FIGS. 15 (a) and (b), the micro pump (50) has been substituted by a hyperbaric chamber (53) and a normally closed electro valve (54). When the electro valve (54) is in OFF position (closed) the sealant liquid foam stays inside the tank (4); when the electro valve (54) is in ON position (open) the pressurized gas inside the hyperbaric chamber (53) goes into the tank (4) so that the termination piston (51) of the FIG. 15 (a), or the plug (52) of FIG. 15 (b), is pushed out of the tank (4) thus allowing the internal sealant fluid foam to get inside the tire.

### The Sealant Liquid Foam Recharging System

In the embodiments of FIGS. 8, 13 and 15 (a), the actuated and/or the termination pistons (24), (25), (44), (45) and (51) can be totally removed so that the tank (4) can be recharged with the sealant liquid foam as needed. In the embodiment of FIGS. 15 (b) and 16 the plug (52) can be totally removed to recharge the tank with sealant liquid, as needed.

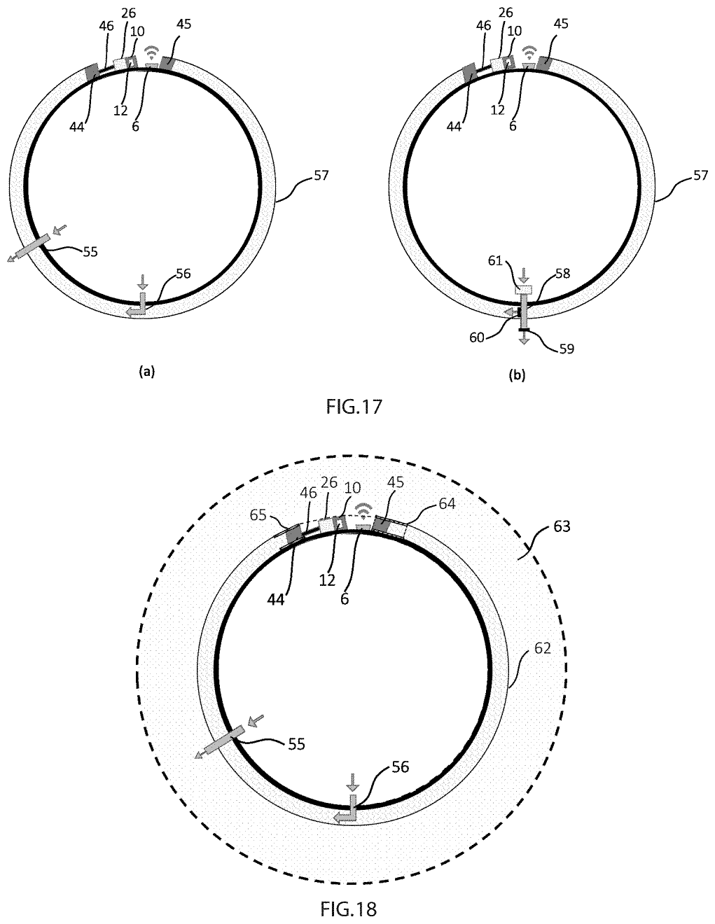

Another embodiment of the recharging system shown in FIG. 17 (a), envisions the presence of a flexible tank (57) and two distinct valves, one (55) to inflate the tire with air, and one (56) to recharge the sealant liquid foam into the flexible tank (57). This enables the system to be assembled around the wheel rim (if not already integrated into the rim itself) before the tire is mounted around the rim. When the tire is mounted around the rim but not inflated, the valve (56) will be set to inflate sealant liquid foam into the flexible tank (57); then, air is inflated in the tire by the pneumatic valve (55). One of the pressure balancing mechanisms previously described will assure isostatic pressure between the sealant liquid foam inside the flexible tank (57) and the pressurized air in the tire. The valve (56) allows also the sealant liquid foam to flow out from the flexible tank (57), when needed. Indeed, in the event of a tire change it can be possible to empty preventively the flexible tank (57) by opening the valve (56) or to maintain the tank (57) still full since the pressure balancing mechanism will maintain the dynamic isostatic pressure between the sealant liquid foam inside the flexible tank (57) and the decreasing pressure of the air in the tire, thus avoiding the spill of sealant or unwanted opening of the terminations.

In the embodiment of FIG. 17 (b) one valve (58) having two outputs, one (59) to inflate the tire with air, and one (60) to recharge the sealant liquid foam into the flexible tank (57), and a selector (61) to select the opening/closing of the output (59) or (60), are implemented. When the tire is mounted around the rim but not inflated, the selector (61) sets the opening of the output (60) and the closing of output (59) so that the flexible tank (57) will be prefilled with sealant at low pressure through this output (60) (termination sensors could be exploited to acoustically inform that the flexible tank (57) is full); then the selector (61) sets the opening of the output (59) and the closing of output (60) thus permitting the air to be inflated in the tire up to the desired pressure. The valve (58) also allows the sealant liquid foam to flow out from the flexible tank (57), when needed. Indeed, in the event of a tire change it can be possible to empty preventively the flexible tank (57) by opening the valve (60) or to maintain the tank (57) still full since the pressure balancing mechanism will maintain the dynamic isostatic pressure between the sealant liquid foam inside the flexible tank (57) and the decreasing pressure of the air in the tire, thus avoiding the spill of sealant or unwanted opening of the terminations.

A custom designed valve (58) can be exploited in order to allow selection of inflation of air or sealant, as needed.

### The Energy Source

One or more energy sources and one or more supply connections are required to supply energy at least to the actuation mechanism, the sensing module and the communication module. The energy source or batteries may or may not be accessible to be changed.

In a further embodiment of the present invention, the energy source (12) can also be complemented and/or in part (or totally) replaced with an appropriate energy harvesting system (e.g., magnetic or electromagnetic energy harvesting, or a system that exploits vibration energy produced by the movement of the car or the rotatory movement of the wheel).

### Some Specific Embodiments

In the following are discussed in details, few more embodiments examples of the present invention, so as to further clarify how to implement the disclosed system.

In FIG. 18 the key components of the preferred embodiment of the proposed system, exploiting an air-chamber (62) as flexible tank for the sealant liquid foam and placed around the wheel rim of a tire (63), are displayed. The system includes:
a modified air-chamber (62) exploited as flexible tank to keep sealant liquid foam;
two rigid cylinders (64) and (65) inserted in the modified air-chamber (62);
a termination piston (45) inserted in the rigid cylinder (64) where said termination piston (45) is able to move axially inside said cylinder (64) acting as the aforementioned pressure stabilizing mechanism;
an actuated piston (44) inserted in the rigid cylinder (65) where said actuated piston (44) is able to move axially inside said cylinder (65) and pushed out of the cylinder (65), thus acting as an opening for the air-chamber (62);
a communication module (6) able to receive or receive and transmit data/info/commands to control the system actuation or to provide sensors data to car central system;
a sensing module (10);
an energy source (12) (for example batteries);
a micro motor (26) which is connected to the actuated piston (44) by a string (46) to push out of the cylinder (65) the actuated piston (44), thus allowing the sealant liquid foam to get out of the air-chamber (62) when critical pressure conditions for the tire (63) are revealed by sensors (for example, a TPMS implemented in the sensing module (10));
a pneumatic valve (55) to inflate air into the tire (63) (as a standard air-wheel valve);
a valve (56) to inflate sealant liquid foam into the modified air-chamber (62).

The proposed system according to the preferred embodiment is assembled around the wheel rim before the tire is mounted around the rim; the system is empty and it needs only to be secured around the wheel; when the tire (63) is mounted around the rim but not inflated, the valve (56) will permit to inflate sealant liquid foam into the modified air-chamber (62); then air will be inflated into the tire (63) by the pneumatic valve (55) up to the desired pressure. The axial movement of the termination piston (45) inserted in the rigid cylinder (64) will assure isostatic pressure between the sealant liquid foam in the air-chamber (62) and the pressurized air in the tire (63); upon a command (or automatically if pre-set so) the valve (56) can be electrically or manually controlled to allow the sealant liquid foam to flow out from the air-chamber. In the event of a tire change with the air-chamber (62) still full of the sealant liquid foam, this pressure stabilizing mechanism avoids the spill of sealant liquid foam or unwanted opening of the terminations. In a more general way, the aforementioned or others pressure stabilization mechanisms can be placed in any position of the tank or air-chamber.

In the most general implementation of the present invention, many other sensors and actuators can be integrated with the proposed invention. E.g., vibrational sensors can be used to monitor the amount of car vibration so as to increase car safety (e.g. alerting the driver if the car vibrations average had changed over time which can signal a damage in the car). Other possible monitoring systems includes balancing monitoring with or without automatic compensation, temperature monitoring, tire wear degradation monitoring (this can also be monitored by an IR system placed under the car fenders). In addition, the TPMS can be integrated in the proposed system or replaced by an infrared system placed under the car fenders. Furthermore, many electronic components and/or the energy source and/or the communication module of the disclosed system could be mounted outside the tire air-chamber and connected to the actuation mechanism through a valve.

In a further embodiment of the present invention, the ring (or wheel) comprises also a mini-compressor that is used to maintain the air pressure inside the tires constant or in general to allow for easy inflation of the same when required. The mini-compressor can comprise a valve connected to the external side of the wheel so as to be able to pump air inside the tire when the inside pressure drops under a preselected threshold level.

In order to increase the flow rate of the sealant, from the tank to the tire chamber, when the system is activated, the discosed system can embedd a mechanical system comprising springs, pistons, plungers, pumps and/or compressed air chamber sectors inside the cavity

As it is clear to those skilled in the art, this basic system can be implemented in many specific ways, and the above descriptions are not meant to designate a specific implementation.

What is claimed is:

1. A smart wheel system comprising:
a tank, and
an actuation mechanism;
wherein said tank is composed with materials belonging to the group comprising flexible, rigid and semi-rigid materials;
wherein said tank comprises a cavity to host an element belonging to the group comprising foam, tire sealing material and compressed air, and
wherein said actuation mechanism allows the flow of said element from said cavity to an inner part of a tire, when an activation signal is provided.

2. A smart wheel according to claim 1,
wherein said cavity is integrated inside a rim of a wheel.

3. A smart wheel according to claim 1,
wherein said smart wheel system is at least partially implemented in an add-on removable structure.

4. A smart wheel according to claim 1,
wherein said actuation mechanism comprises a mechanism belonging to the group comprising an electro-valve, a latched electro-valve, a multi synchronous I/O electro-valve (EV), a pump, a non-returning valve, a plunger, plunger connected to a micro-motor.

5. A smart wheel according to claim 1, further comprising a pressure balancing mechanism;
wherein said pressure balancing mechanism is used to maintain an isostatic balance between pressurized air inside the tire and the element inside the cavity.

6. A smart wheel according to claim 1, further comprising a sensing module,
wherein said sensing module is used to monitor an environment parameter inside said tire;
wherein said activation signal is generated when a quantity derived from said parameter has overcome a threshold value.

7. A smart wheel according to claim 1, wherein said activation signal is generated automatically by means of a decision algorithm based on a sensor reading.

8. A smart wheel according to claim 1, further comprising a communication module,
wherein said communication module comprises an RF transceiver or receiver unit;
wherein said activation signal is generated when an RF signal is received and processed by said RF transceiver or receiver unit.

9. A smart wheel according to claim 1, further comprising a communication module,
wherein said communication module comprises an RF transceiver unit;
wherein said transceiver unit is connected to a sensor, and
wherein said sensor provides to a central unit a monitoring of a local parameter belonging to the group comprising temperature, pressure, and acceleration.

10. A smart wheel according to claim 1, further comprising one or more energy storage elements.

11. A smart wheel according to claim 1, further comprising an energy harvesting system.

12. A smart wheel according to claim 1,
wherein said cavity is a first cavity to be filled with sealant material;
wherein said tank comprises a second cavity to be filled with compressed air, and
wherein said second cavity can be opened and closed by means of a second activation mechanism to reestablish or increase the internal pressure of said tire after the sealant material has been expelled from said first cavity.

13. A smart wheel according to claim 1, wherein said tank comprises a mechanism to increase the flow of the sealant foam, when said activation signal is provided.

14. A smart wheel according to claim 1, wherein said cavity has an internal pressure higher than the pressure inside said tire.

15. A smart wheel according to claim 1, further comprising a closed ring or a belt around a rim of a wheel and a self-lock mechanism to close said ring or belt around said rim with a flexible, semi-rigid or rigid lock mechanism.

16. A smart wheel according to claim 15, further comprising a second level of locking mechanism to increase reliability, safety, and hold strength of said belt/ring around the rim.

17. A smart wheel according to claim 15,
wherein said self-lock mechanism comprises a system to monitor the status of said self-lock mechanism, and
wherein a warning signal is generated by said system when the lock mechanism fails.

18. A smart wheel according to claim 1, further comprising a tank recharging system comprising one valve having a first and a second output,
wherein a selector mechanism is used to select the opening/closing of said first and second outputs, and
wherein said first output is used to inflate the tire with air, and said second output is used to recharge said tank.

19. A smart wheel system comprising:
a wheel add-on structure comprising a tank;
an actuator;
wherein said tank is composed with materials belonging to the group comprising flexible, rigid and semi-rigid materials;
wherein said tank comprises a cavity to contain an element belonging to the group comprising foam, tire sealing material and compressed air, and
wherein said actuation mechanism allows the flow of said element from said cavity to an inner part of a tire, when an activation signal is provided.

20. A smart wheel system comprising:
a closed ring or a belt around a wheel rim;
an actuator;
wherein said closed ring or belt comprises a tank;
wherein said tank is composed with materials belonging to the group comprising flexible, rigid and semi-rigid materials;
wherein said tank comprises a cavity to contain an element belonging to the group comprising foam, tire sealing material and compressed air, and
wherein said actuation mechanism allows the flow of said element from said cavity to an inner part of a tire, when an activation signal is provided.
